(19) United States
(12) Patent Application Publication
(10) Pub. No.: US 2022/0010057 A1
(43) Pub. Date: Jan. 13, 2022

(54) Novel Polyglycolic Acid and Preparation Method Thereof by Polycondensation

(71) Applicant: Pujing Chemical Industry Co., Ltd., Shanghai (CN)

(72) Inventor: Chuangyang LI, Shanghai (CN)

(21) Appl. No.: 17/289,460

(22) PCT Filed: Oct. 29, 2018
(86) PCT No.: PCT/CN2018/112477

§ 371 Date: Apr. 28, 2021

(51) Int. Cl. C08G 63/06; C08G 63/84; C08G 63/20; C08K 5/29

(52) U.S. Cl. CPC C08G 63/06; C08K 5/29; C08G 63/20; C08G 63/84

(57) ABSTRACT

The invention relates a novel polyglycolic acid. The polyglycolic acid comprises branched repeating units and linear repeating units. The polyglycolic acid may be produced from methyl glycolate by polycondensation in the presence of structure regulators, and exhibit excellent melt strength and thermal stability while maintaining good flowability and suitability for use in melt blow molding.

### FIELD OF THE INVENTION

The invention relates to a novel structure of polyglycolic acid (PGA) obtained by polycondensation of methyl glycolate, and preparation thereof.

### BACKGROUND OF THE INVENTION

As a new type of biodegradable material, polyglycolic acid (PGA) has excellent gas barrier properties and mechanical properties. As environmental protection becomes more and more important, it has attracted more and more attention as an environmentally friendly and degradable packaging material.

Blow molding process is an important means for processing resin materials into packaging products. Melt strength and flowability are key characteristics for molding processes such as extrusion blow molding and stretch blow molding. In the process of obtaining a hollow packaging container by an extrusion blow molding process, the resin materials are melted and then a parison of the desired length is extruded downward through an annular opening or a die. The parison is inflated into a bubble in a mold, and then subjected to cooling and trimming to obtain the desirable product. When the parison is formed, if the melt strength is insufficient, the weight of the bubble will not be supported, when the parison exceeds a certain length, the upper of the parison cannot withstand the weight of the parison, which causes circumferential stress, resulting in wrinkles, stretching or elongation of the parison. As a result, a uniform thickness of a parison cannot be formed. Moreover, the parison may fracture and the inner wall of the parison may be stuck such that the next inflation process cannot be performed to obtain a molded article. During the inflation process, the parison may become larger in lateral expansion volume under the action of compressed air, and the wall thickness may become thin. If the melt strength is insufficient, the parison cannot undergo inflation and thus cracks, while higher melt strength can withstand a larger inflation ratio, such that the same amount of material can produce a larger container. In order to improve the physical properties of the plastic or reduce the cost, it is necessary to stretch the parison in the longitudinal direction by the action of internal (stretched mandrel) or external (stretching jig) mechanical force combined with the lateral inflation. The requirement of melt strength is higher, otherwise it cannot bear the dual effects of stretching and inflation, which may cause uneven thickness or even cracking of the product.

Chinese patent CN102971358B discloses high melt strength obtained when making polyester with high intrinsic viscosity, and finally is used in processing such as extrusion blow molding. However, merely increasing the intrinsic viscosity to increase the melt strength causes deterioration of the flowability of the resin.

Due to poor flowability, a resin cannot be easily processed and results in surface defects or shark skin of a resulting molded article. It may even become impossible or very expensive to make a molded article. In order to deal with the poor flowability, a high processing temperature or processing with large energy consumption may be needed. A high processing temperature may result in thermal degradation and discoloration. Processing with large energy consumption may cause an increase in cost or an extended molding cycle, thereby reducing processing efficiency.

Many studies have focused on improving melt strength and flowability of resins for use in processes such as blow molding. Chinese patent CN10057731C discloses the use of polylactic acid resin alloy to improve flowability and melt strength of plastics for blow molding and other processes. However, compatibility of two resins needs to address for an alloy. Chinese patent CN1216936C reports the use of compositions of ultra-high molecular weight polyethylene resin and various auxiliaries to obtain sufficient flowability and melt strength for blow molding.

There remains a need for a polyglycolic acid (PGA) having excellent melt strength while maintaining good flowability.

### SUMMARY OF THE INVENTION

The present invention provides a polyglycolic acid of a novel structure and preparation thereof by polycondensation in the presence of a structure regulator.

A polyglycolic acid is provided. The polyglycolic acid comprises first repeating units of formula (I) and second repeating units of E-R₂—F. Formula (I) is

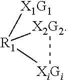

R₁ and R₂ are each an aliphatic or aromatic group; G₁, G₂ . . . Gᵢ are

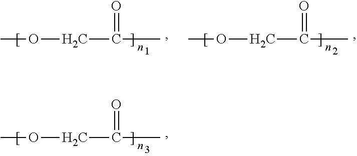

respectively; i is greater than 3; and X1, X2 . . . Xi, E and F are each —NH—C(O)—, —O—, —NH— or —C(O)— except:

(a) when each of X1, X2 . . . Xi is —O— or —NH—, E and F are each —NH—C(O)— or —C(O)—; and

(b) when each of X1, X2 . . . Xi is —NH—C(O)— or —C(O)—, E and F are each —O— or —NH—.

In one embodiment of the polyglycolic acid, X₁ is —O— or —NH—, X₂ is —C(O)—, E and F are each —NH—, —NH—C(O)—, —O— or —C(O)—.

In another embodiment of the polyglycolic acid, each of X₁, X₂ . . . Xᵢ is —O— or —NH—, and E and F are the same and are either —NH—C(O)— or —C(O)—.

In yet another embodiment of the polyglycolic acid, each of X₁, X₂ . . . Xᵢ is —C(O)— or —NH—C(O)—, and E and F are each —O— or —NH—.

The polyglycolic acid may be prepared from methyl glycolate by polycondensation in the presence of a structure regulator.

The polyglycolic acid may be prepared according to a three-stage process comprising: (a) esterifying methyl glycolate in the presence of an esterification catalyst and a structure regulator A in an esterification reactor, whereby a melted pre-esterified polymer is formed; (b) polycondensing the melted pre-esterified polymer in the presence of a polycondensation catalyst in a polycondensation reactor, whereby a polyglycolic acid based polymer is formed; and (c) optimizing the polyglycolic acid based polymer in the presence of a structure regulator B in a devolatilization reactor at 200-250° C., under an absolute pressure of not more than 1000 Pa for 10 min to 4 h, whereby the polyglycolic acid is formed.

The esterification catalyst may comprise a tin salt, a zinc salt, a titanium salt, a sulfonium salt, a tin oxide, a zinc oxide, a titanium oxide, a sulfonium oxide, or a combination thereof.

The polycondensation catalyst may comprise an oxide, compound or complex of a rare earth element selected from the group consisting of cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y), or a combination thereof

In one embodiment, the esterification catalyst is tin dichloride dihydrate and the polymerization catalyst is a rare earth catalyst.

The structure regulator A may be C1m-R1-D1n (m+n≥3) and the structure regulator B may be C2-R2-D2. Each of C1, C2, D1 and D2 may be —OH, —COOH, —NH₂, —COOR5 or —N═C═O. Each of R1, R2 and R5 may be an aliphatic or aromatic group. The structure regulator A may be a polyol, a polycarboxylic acid, a polyhydroxypolycarboxyl compound (i.e., a multi-functional compound comprising both an alcoholic hydroxyl group and a carboxyl group), a polyhydroxypolyester compound (i.e., a multi-functional compound comprising both an alcoholic hydroxyl group and an ester group), a polyaminopolycarboxyl compound (i.e., a multi-functional compound comprising both an amino group and a carboxyl group) or a polyaminopolyhydroxy compound (i.e., a multi-functional compound comprising both an amino group and an alcoholic hydroxyl group). m+n may be 3-8, preferably 3. The structure regulator B may be a diisocyanate, a diamine, a dibasic acid or a diol.

In one embodiment of the polyglycolic acid, the structure regulator A is a polyol, a polyhydroxypolyester compound or a polyhydroxypolycarboxyl compound, and the structure regulator B is a diisocyanate.

In another embodiment of the polyglycolic acid, the structure regulator A is a polycarboxylic acid and the structure regulator B is a diol.

The polyglycolic acid may have a melt index of 5-30 g/10 min at 230° C. and a load of 2.16 g; melt strength of 50-300 mN at 230° C. and an acceleration rate at about 1.2 cm/s²; and/or a temperature of 270° C. or higher when a weight loss rate reaches 3% after being heated starting from room temperature at a heating rate of 2° C./min under a nitrogen atmosphere.

Compared with a linear polyglycolic acid having a similar melt index, the polyglycolic acid of the present may have a much higher melt strength.

The polyglycolic acid may be molded by blowing, for example, blow molding.

### DETAILED DESCRIPTION OF THE INVENTION

The invention provides a polyglycolic acid (PGA) having a novel structure prepared by a polycondensation method. The invention was made based on the inventor's surprising discovery of a PGA having a novel branched structure prepared from methyl glycolate by polycondensation in the presence of a structure regulator showed excellent melt strength and thermal stability while maintaining good flowability and is suitable for use in melt blow molding.

The PGA of the invention has a branched structure, which has a large molecular volume, the branched molecules having a larger molecular volume are further connected via a linear structure, and the molecular volume is further increased. That is to say, the novel structure which is formed by chemical bonding of the branched structures via a linear structure results in a satisfactory molecular volume, which in turn exhibits excellent melt strength. The thermal decomposition temperature of the PGA increases, thereby exhibiting better thermal stability. The melt index is regarded as an index of flowability in processing of a polymer. It is not only limited by the molecular weight of the polymer, but also affected by the molecular structure of the polymer. The PGA of the present invention has shown a similar melt index and a similar flowability but better melt strength and better thermal stability than a linear PGA obtained by ring-opening polymerization of glycolide or polycondensation of methyl glycolate.

The PGA of the present invention can be used for melt blow molding. When melt blow molding under the same conditions for example, a processing temperature of about 230° C. and a mold temperature of about 10-150° C. The blow ratio was 2, and the draw ratio was 2 and the PGA of this invention produced a well molded article, which is defined as an article without collapse and damage and free of surface defects, while a linear PGA having a similar melt index was found incapable of producing a well molded article.

The terms “polyglycolic acid (PGA),” “poly(glycolic acid) (PGA)” and “polyglycolide” are used herein interchangeably and refer to a biodegradable, thermoplastic polymer composed of monomer glycolic acid. A polyglycolide may be prepared by polycondensation or ring-opening polymerization. An additive may be added to the PGA to achieve a desirable property.

The term “structure regulator” used herein refers to an agent used in making the PGA to change the structure of the resulting PGA. One or more structure regulators may be used in the same or different steps of the PGA preparation process.

A polyglycolic acid is provided. The polyglycolic acid comprises first repeating units of formula (I) and second repeating units of E-R₂—F. Formula (I) is

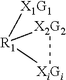

R₁ and R₂ are each an aliphatic or aromatic group; G₁, G₂ . . . Gᵢ are

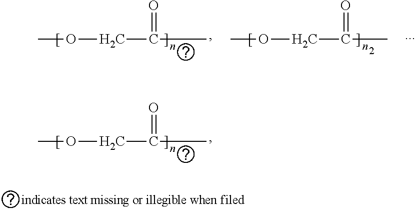

respectively; i is greater than 3; and X1, X2 . . . Xi, E and F are each —NH—C(O)—, —O—, —NH— or —C(O)— except:

(a) when each of X1, X2 . . . Xi is —O— or —NH—, E and F are each —NH—C(O)— or —C(O)—; and

(b) when each of X1, X2 . . . Xi is —NH—C(O)— or —C(O)—, E and F are each —O— or —NH—.

In one embodiment of the polyglycolic acid, X₁ is —O— or —NH—, X₂ is —C(O)—, and E and F are each —NH—, —NH—C(O)—, —O—, or —C(O)—.

In another embodiment of the polyglycolic acid, each of X₁, X₂ . . . Xᵢ is —O— or —NH—, and E and F are the same and are either —NH—C(O)— or —C(O)—.

In yet another embodiment of the polyglycolic acid, each of X₁, X₂ . . . Xᵢ is —C(O)— or —NH—C(O)—, and E and F are each —O— or —NH—.

The PGA of the present invention may be prepared from methyl glycolate by polycondensation in the presence of a structure regulator. For example, the PGA may be obtained by a three-stage reaction process: esterification reaction, polycondensation reaction, and optimization reaction.

In the first step, methyl glycolate is esterified in the presence of an esterification catalyst and a structure regulator A in an esterification reaction to form a branched esterification mixture. The esterification catalyst may be present in an amount of about 0.0001-5.0000 wt % or 0.0001-0.01 wt % of the methyl glycolate. The structure regulator A may be present in an amount no more than about 5 wt % of the methyl glycolate. The esterification reaction may carried out under esterification conditions, including a mixing speed (Rotation Speed A) of about 1-100 rpm, a gauge pressure (PaG_{A}) of about 0-0.5 MPa, a reaction temperature (T_{A}) of about 120-200° C., and a reaction time (t_{A}) about 30 min to about 4 h.

In the second step, the esterification mixture is polycondensated in the presence of a polycondensation catalyst in a polycondensation reactor to form a polycondensation mixture. The polycondensation catalyst may be present in an amount of about 10⁻⁶-10⁻³ parts of the methyl glycolate. The polycondensation catalyst may be a rare earth catalyst. The polycondensation reaction may be carried out under polycondensation conditions, including a mixing speed (Rotation Speed B) of about 1-100 rpm, an absolute pressure (PaA_{B}) of about 1-1000 Pa, a reaction temperature (T_{B}) of about 190-240° C., and a reaction time (t_{B}) of about 2-10 h.

In the third step, the polycondensation mixture is optimized in the presence of structure regulator B in a devolatilization reactor to form the PGA. The structure regulator B may be present in an amount not more than about 5 wt % of the methyl glycolate. The optimization may be carried out under optimization conditions, including a mixing speed (Rotation Speed C) of about 1-400 or 1-100 rpm, an absolute pressure (PaA_{C}) of about 1-1000 Pa, a temperature (T_{C}) of about 200-250° C. and a reaction time (t_{C}) from about 10 min to about 4 h.

The PGA produced by polycondensation may be extruded from the end of the devolatilization reactor. The polymer may be cooled from the polycondensation temperature in a molten state, and pulverized into a freezing pulverizer to obtain particles having a mesh number of about 2-300 mesh for detection and processing.

The methyl glycolate may be a coal-based methyl glycolate or any commercially available methyl glycolate obtained by other methods. The methyl glycolate may be substituted by a monomer of

HO—R3-COOR4

wherein R3 and R4 are each an alkyl group, for example, methyl glycolate, ethyl glycolate, propyl glycolate, isopropyl glycolate, butyl glycolate, methyl lactate, propyl lactate, and isopropyl lactate, preferably methyl glycolate.

The use of one or more structure regulators is the key to the synthesis of a PGA having both high strength and excellent flowability. The structure regulator may be in the form of Cx-R-Dy (2≤x+y), in which C and D are each —OH, —NH₂, —COOH, —COOR5, —N═C═O, or a combination thereof. R and R5 are each an aliphatic or aromatic group.

The structure regulator A may be added in the first step. The structure regulator A may be in the form of C1m-R1-D1n (35m+n). C1 and D1 are each —OH, —NH₂, —COOH, —COOR5 or a combination thereof. R1 and R5 are each an aliphatic or aromatic group. The structure regulator A may be a polyhydroxypolycarboxyl compound, such as dimethylolpropionic acid, dimethylolbutanoic acid, 4,5-dihydroxy-2-(hydroxymethyl)pentanoic acid, gluconic acid, hydroxysuccinic acid, hydroxymalonic acid 2-hydroxyglutaric acid, hydroxypropionic acid, or 3-hydroxy-1,3, 5-pentanetricarboxylic acid. The structure regulator A may be a polyol such as 1, 1, 1-trimethylol ethane, 1, 1, 1-trimethylol propane, hexanetriol, butyl alcohol, glycerol, ninhydrin, cyclohexanetriol, heptanetriol, octanetriol, pentaerythritol, butyltetraol, dipentaerythritol, glycerol, xylitol, mannitol, sorbitol, cyclohexanol. The structure regulator A may be a polycarboxylic acid (e.g., propionic acid). The structure regulator A may be a polyhydroxypolyester compound, (e.g., glycerol propionate, glycerol acetate, glycerol butyrate, glycerol diacetate, and dibutyrin). The structure regulator A may be a polyaminopolycarboxyl compound (e.g., 2, 6-diaminocaproic acid, 2, 4-diaminobutyric acid, and glutamic acid). The structure regulator A may be a polyaminopolyhydroxy compound (e.g., 2,6-diamino-1-hexanol, (3R)-2-amino-1,3-butanediol, 2-amino-2-methyl-1,3-propanediol).

The structure regulator A is preferably a trifunctional compound. More preferably, the structure regulator A is 1, 1, 1-trimethylol propane, dibutyrin, dimethylolpropionic acid or hydroxymalonic acid.

The structure regulator B may be added during the third step. The structure regulator B may be in the form of C2-R2-D2. C2 and D2 are each —OH, —NH₂, —COOH, —N═C═O, or a combination thereof. R2 is an aliphatic or aromatic group. The structure regulator B may be a diisocyanate, a dibasic acid, a diamine or a diol. Examples of the structure regulator B include hexamethylene diisocyanate, isophorone diisocyanate, diphenylmethane diisocyanate, xylylene diisocyanate, toluene diisocyanate, adipic acid, glutaric acid, itaconic acid, ethylene glycol, propylene glycol and octanediol, Propanediamine, butanediamine, 1, 5-pentanediamine, 2-methyl-1, 5-pentanediamine, and preferablydiisocyanate. Preferably, the structural regulator B is hexamethylene diisocyanate.

The term “about” as used herein when referring to a measurable value such as an amount, a percentage, and the like, is meant to encompass variations of ±20% or ±10%, more preferably ±5%, even more preferably ±1%, and still more preferably ±0.1% from the specified value, as such variations are appropriate.

### Example 1

Polymers 1-32 and Comparative 1 were prepared and evaluated for their melt strength, melt index, thermal stability, mean square radius of gyration and blow molding.

Polymer 1 was prepared from methyl glycolate. Methyl glycolate, stannous chloride dichloride (esterification catalyst) at 0.01 wt % of the methyl glycolate, dimethylolpropionic acid (structure regulator A) at 1 wt % of the methyl glycolate were mixed in an esterification reactor at 30 rpm, 0.1 MPa (gauge pressure), 180° C. for 90 min. The materials in the esterification reactor material were transferred into a polycondensation reactor. Ce (HCO₃)₄ (polycondensation catalyst) at 5×10⁻⁵ parts of the methyl glycolate was added into the polycondensation reactor. The polycondensation reaction was carried out at 80 rpm and 215° C. for 240 min under an absolute pressure of 100 Pa. The material in the polycondensation reactor was transferred into an optimized reactor and hexamethylene diisocyanate (structure regulator B) at 1 wt % of the methyl glycolate was added. The reaction was carried out at 225° C. for 120 min under an absolute pressure of 50 Pa. Polymers 2 and 3 were prepared in the same way as that for Polymer 1 except that structure regulator A was added at 2 wt % for Polymer 2 or 0.5 wt % for Polymer 3.

Polymer 4 was prepared from methyl glycolate. Methyl glycolate, stannous chloride dichloride (esterification catalyst) at 0.01 wt % of the methyl glycolate, hydroxymalonic acid (structure regulator A) at 1 wt % of the methyl glycolate were mixed in an esterification reactor at 30 rpm, 0.1 MPa (gauge pressure), 175° C. for 75 min. The materials in the esterification reactor material were transferred into a polycondensation reactor. Ce (HCO₃)₄ (polycondensation catalyst) at 5×10⁻⁵ parts of the methyl glycolate was added into the polycondensation reactor. The polycondensation reaction was carried out at 80 rpm and 215° C. for 240 min under an absolute pressure of 100 Pa. The material in the polycondensation reactor was transferred into an optimized reactor and hexamethylene diisocyanate (structure regulator B) at 1 wt % of the methyl glycolate was added. The reaction was carried out at 225° C. for 120 min under an absolute pressure of 50 Pa. Polymers 5 and 6 were prepared in the same way as that for Polymer 1 except that structure regulator A was added at 0.5 wt % for Polymer 5 or 2 wt % for Polymer 6.

Polymer 7 was prepared from methyl glycolate. Methyl glycolate, stannous chloride dichloride (esterification catalyst) at 0.01 wt % of the methyl glycolate, 1, 1, 1-trimethylol propane (structure regulator A) at 1 wt % of the methyl glycolate were mixed in an esterification reactor at 30 rpm, 0.1 MPa (gauge pressure), 180° C. for 100 min. The materials in the esterification reactor material were transferred into a polycondensation reactor. Ce (HCO₃)₄ (polycondensation catalyst) at 5×10⁻⁵ parts of the methyl glycolate was added into the polycondensation reactor. The polycondensation reaction was carried out at 80 rpm and 215° C. for 240 min under an absolute pressure of 100 Pa. The material in the polycondensation reactor was transferred into an optimized reactor and hexamethylene diisocyanate (structure regulator B) at 1 wt % of the methyl glycolate was added. The reaction was carried out at 225° C. for 120 min under an absolute pressure of 50 Pa.

Polymer 8 was prepared from methyl glycolate. Methyl glycolate, stannous chloride dichloride (esterification catalyst) at 0.01 wt % of the methyl glycolate, dibutyrin (structure regulator A) at 1 wt % of the methyl glycolate were mixed in an esterification reactor at 30 rpm, 0.1 MPa (gauge pressure), 180° C. for 100 min. The materials in the esterification reactor material were transferred into a polycondensation reactor. Ce (HCO₃)₄ (polycondensation catalyst) at 5×10⁻⁵ parts of the methyl glycolate was added into the polycondensation reactor. The polycondensation reaction was carried out at 80 rpm and 215° C. for 240 min under an absolute pressure of 100 Pa. The material in the polycondensation reactor was transferred into an optimized reactor and hexamethylene diisocyanate (structure regulator B) at 1 wt % of the methyl glycolate was added. The reaction was carried out at 225° C. for 120 min under an absolute pressure of 50 Pa.

Polymers 9-32 were prepared in the same way as that for Example 1 except that some process parameters were changed. The parameters are shown in Table 1.

Comparative example 1 was a linear polyglycolic acid was obtained from a glycolide by ring-opening polymerization without a structure regulator.

Polymers 1-32 and Comparative 1 were evaluated in the following tests and the results are shown in Table 2.

1. Melt Index Test

The melt index (MFR) of a sample was tested according to the following: 1) drying a test sample in a vacuum drying oven at 105° C.; 2) setting the test temperature of the melt index test instrument to 230° C. and preheating the instrument; 3) loading 4 g of the dried sample into a barrel through a funnel and inserting a plunger into the barrel to compact the dried sample into a rod; 4) keeping the dried sample in the rod for 1 min with a weight of 2.16 kg pressing on top of the rod, and then cutting a segment every 30s to obtain a total of five segments; 5) weighing the mass of each sample MFR=600 W/t (g/10 min), where W is the average mass per segment of the sample and t is the cutting time gap for each segment.

2. Melt Strength Test

The melt strength of a sample was measured using an Italian CEAST Rheologic 5000 capillary rheometer and a “Haul-off” melt strength test module. The sample was extruded at a constant speed by a plunger and fall through a capillary outlet into a set of counter-rotating clamps with a vertical distance of 195 mm from the outlet. The pinch rolls rotated at a constant acceleration to stretch the melt strip. The tensile force increases continuously until the melt breaks. The force at this time is the “melt strength,” and is reported as mN. The test parameters: a temperature at about 230° C., and an acceleration rate at about 1.2 cm/s².

3. Thermal Stability

The thermal stability of a sample was measured using the NETZSCH TG 209 F3 thermogravimetric analyzer of NETZSCH ATST. 10 mg of a powder sample was used. The temperature was raised from about 25° C. at a heating rate of about 2° C./min under the conditions of a nitrogen flow rate of 10 mL/min. The temperature was measured when a 3 wt % loss was measured.

4. Mean Square Radius of Gyration

A mean square radius of gyration was determined by using a laser light scattering instrument (helium/neon laser generator power: 22 mW) of the German ALV company CGS-5022F type to measure the mean square radius of gyration of the polymer. A polymer sample was dried to a constant weight in a vacuum oven at 50° C. Hexafluoroisopropanol (HPLC grade) was used as a solvent at 25° C. to prepare a polymer having a concentration of C₀=0.001 g/g polymer/hexafluoroisopropanol solution. Four concentrations C₀, 3/4C₀, 1/2C₀ and 1/4C₀ of the polymer/hexafluoroisopropanol solution were prepared by dilution and filtering through a 0.2 μm filter. The test wavelength was 632.8 nm; the scattering angle range was 15-150 degrees; and the test temperature was 25 f 0.1° C.

5. Blow Molding

A hollow container was prepared by molding in a blowing mold apparatus at a thermoplastic processing temperature of about 230° C. and a mold temperature of about 10-150° C. The blow ratio was 2, and the draw ratio was 2. The processing performance was evaluated according to the following criteria:

A: Very good blow molding when the sample could form a defect-free article continuously for a long period of time.

B: Blow molding can be performed, but the surface is defective or shark skin phenomenon occurs.

C: Unable to blow molding when it was impossible to blow out a complete article because it may be broken or collapsed.

TABLE 1
Synthesis parameters

| | | | | structure | Rotation | | | | | | structure | Rotation | | | | Rotation | | | |
|---|---|---|---|---|---|---|---|---|---|---|---|---|---|---|---|---|---|---|---|
| | | stannous | structure | regulator | Speed | | | | | structure | regulator | Speed | | | | Speed | | | |
| | methyl | chloride | regulator | A | A | PaG_{A}/ | T_{A}/ | t_{A}/ | Ce | regulator | B | B/ | PaA_{B}/ | T_{B}/ | t_{B}/ | C/ | PaA_{C}/ | T_{C}/ | t_{C}/ |
| NO | glycolate | dichloride | A | dosage | RPM | MPa | ° C. | min | (HCO₃)₄ | B | dosage | RPM | Pa | ° C. | min | RPM | Pa | ° C. | min |
| Polymer1 | 1 | 10⁻⁴ | dimethylol | 0.01 | 30 | 0.1 | 180 | 90 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer2 | 1 | 10⁻⁴ | dimethylol | 0.02 | 30 | 0.1 | 180 | 90 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer3 | 1 | 10⁻⁴ | dimethylol | 0.005 | 30 | 0.1 | 180 | 90 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer4 | 1 | 10⁻⁴ | hydroxymalonic | 0.01 | 30 | 0.1 | 175 | 75 | 5*10⁻⁵ | hexamethylene | 0.01 | 80 | 100 | 215 | 240 | 180 | 50 | 225 | 120 |
| | | | acid | | | | | | | diisocyanate | | | | | | | | | |
| Polymer5 | 1 | 10⁻⁴ | hydroxymalonic | 0.005 | 30 | 0.1 | 175 | 75 | 5*10⁻⁵ | hexamethylene | 0.01 | 80 | 100 | 215 | 240 | 180 | 50 | 225 | 120 |
| | | | acid | | | | | | | diisocyanate | | | | | | | | | |
| Polymer6 | 1 | 10⁻⁴ | hydroxymalonic | 0.02 | 30 | 0.1 | 175 | 75 | 5*10⁻⁵ | hexamethylene | 0.01 | 80 | 100 | 215 | 240 | 180 | 50 | 225 | 120 |
| | | | acid | | | | | | | diisocyanate | | | | | | | | | |
| Polymer7 | 1 | 10⁻⁴ | 1,1,1- | 0.01 | 30 | 0.1 | 180 | 100 | 5*10⁻⁵ | hexamethylene | 0.01 | 80 | 100 | 215 | 240 | 180 | 50 | 225 | 120 |
| | | | trimethylolpropane | | | | | | | diisocyanate | | | | | | | | | |
| Polymer8 | 1 | 10⁻⁴ | dibutyrin | 0.0 | 30 | 0.1 | 180 | 10 | 5*10⁻⁵ | hexamethylene | 0.01 | 80 | 100 | 215 | 240 | 180 | 50 | 225 | 120 |
| | | | | | | | | | | diisocyanate | | | | | | | | | |
| Polymer9 | 1 | 10⁻⁴ | dimethylol | 0.01 | 1 | 0.1 | 180 | 90 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer10 | 1 | 10⁻⁴ | dimethylol | 0.01 | 100 | 0.1 | 180 | 90 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer11 | 1 | 10⁻⁴ | dimethylol | 0.01 | 30 | 0 | 180 | 90 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer12 | 1 | 10⁻⁴ | dimethylol | 0.01 | 30 | 0.5 | 180 | 90 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer13 | 1 | 10⁻⁴ | dimethylol | 0.01 | 30 | 0.1 | 120 | 90 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer14 | 1 | 10⁻⁴ | dimethylol | 0.01 | 30 | 0.1 | 200 | 90 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer15 | 1 | 10⁻⁴ | dimethylol | 0.01 | 30 | 0.1 | 180 | 30 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer16 | 1 | 10⁻⁴ | dimethylol | 0.01 | 30 | 0.1 | 180 | 240 | 5*10⁻⁵ | hexamethylene | 0.01 | 80 | 100 | 215 | 240 | 180 | 50 | 225 | 120 |
| | | | propionic acid | | | | | | | diisocyanate | | | | | | | | | |
| Polymer17 | 1 | 10⁻⁴ | dimethylol | 0.01 | 30 | 0.1 | 180 | 90 | 5*10⁻⁵ | hexamethylene | 0.01 | 1 | 100 | 215 | 240 | 180 | 50 | 225 | 120 |
| | | | propionic acid | | | | | | | diisocyanate | | | | | | | | | |
| Polymer18 | 1 | 10⁻⁴ | dimethylol | 0.01 | 30 | 0.1 | 180 | 90 | 5*10⁻⁵ | hexamethylene | 0.01 | 200 | 100 | 215 | 240 | 180 | 50 | 225 | 120 |
| | | | propionic acid | | | | | | | diisocyanate | | | | | | | | | |
| Polymer19 | 1 | 10⁻⁴ | dimethylol | 0.01 | 30 | 0.1 | 180 | 90 | 5*10⁻⁵ | hexamethylene | 0.01 | 80 | 1 | 215 | 240 | 180 | 50 | 225 | 120 |
| | | | propionic acid | | | | | | | diisocyanate | | | | | | | | | |
| Polymer20 | 1 | 10⁻⁴ | dimethylol | 0.01 | 30 | 0.1 | 180 | 90 | 5*10⁻⁵ | hexamethylene | 0.01 | 80 | 1000 | 215 | 240 | 180 | 50 | 225 | 120 |
| | | | propionic acid | | | | | | | diisocyanate | | | | | | | | | |
| Polymer21 | 1 | 10⁻⁴ | dimethylol | 0.01 | 30 | 0.1 | 180 | 90 | 5*10⁻⁵ | hexamethylene | 0.01 | 80 | 100 | 190 | 240 | 180 | 50 | 225 | 120 |
| | | | propionic acid | | | | | | | diisocyanate | | | | | | | | | |
| Polymer22 | 1 | 10⁻⁴ | dimethylol | 0.01 | 30 | 0.1 | 180 | 90 | 5*10⁻⁵ | hexamethylene | 0.01 | 80 | 100 | 240 | 240 | 180 | 50 | 225 | 120 |
| | | | propionic acid | | | | | | | diisocyanate | | | | | | | | | |
| Polymer23 | 1 | 10⁻⁴ | dimethylol | 0.01 | 30 | 0.1 | 180 | 90 | 5*10⁻⁵ | hexamethylene | 0.01 | 80 | 100 | 215 | 120 | 180 | 50 | 225 | 120 |
| | | | propionic acid | | | | | | | diisocyanate | | | | | | | | | |
| Polymer24 | 1 | 10⁻⁴ | dimethylol | 0.01 | 30 | 0.1 | 180 | 90 | 5*10⁻⁵ | hexamethylene | 0.01 | 80 | 100 | 215 | 600 | 180 | 50 | 225 | 120 |
| | | | propionic acid | | | | | | | diisocyanate | | | | | | | | | |
| Polymer25 | 1 | 10⁻⁴ | dimethylol | 0.01 | 30 | 0.1 | 180 | 90 | 5*10⁻⁵ | hexamethylene | 0.01 | 80 | 100 | 215 | 240 | 1 | 50 | 225 | 120 |
| | | | propionic acid | | | | | | | diisocyanate | | | | | | | | | |
| Polymer26 | 1 | 10⁻⁴ | dimethylol | 0.01 | 30 | 0.1 | 180 | 90 | 5*10⁻⁵ | hexamethylene | 0.01 | 80 | 100 | 215 | 240 | 400 | 50 | 225 | 120 |
| | | | propionic acid | | | | | | | diisocyanate | | | | | | | | | |
| Polymer27 | 1 | 10⁻⁴ | dimethylol | 0.01 | 30 | 0.1 | 180 | 90 | 5*10⁻⁵ | hexamethylene | 0.01 | 80 | 100 | 215 | 240 | 180 | 1 | 225 | 120 |
| | | | propionic acid | | | | | | | diisocyanate | | | | | | | | | |
| Polymer28 | 1 | 10⁻⁴ | dimethylol | 0.01 | 30 | 0.1 | 180 | 90 | 5*10⁻⁵ | hexamethylene | 0.01 | 80 | 100 | 215 | 240 | 180 | 1000 | 225 | 120 |
| | | | propionic acid | | | | | | | diisocyanate | | | | | | | | | |
| Polymer29 | 1 | 10⁻⁴ | dimethylol | 0.01 | 30 | 0.1 | 180 | 90 | 5*10⁻⁵ | hexamethylene | 0.01 | 80 | 100 | 215 | 240 | 180 | 50 | 200 | 120 |
| | | | propionic acid | | | | | | | diisocyanate | | | | | | | | | |
| Polymer30 | 1 | 10⁻⁴ | dimethylol | 0.0 | 30 | 0.1 | 180 | 90 | 5*10⁻⁵ | hexamethylene | 0.01 | 80 | 100 | 215 | 240 | 180 | 50 | 250 | 120 |
| | | | propionic acid | | | | | | | diisocyanate | | | | | | | | | |
| Polymer31 | 1 | 10⁻⁴ | dimethylol | 0.01 | 30 | 0.1 | 180 | 90 | 5*10⁻⁵ | hexamethylene | 0.01 | 80 | 100 | 215 | 240 | 180 | 50 | 225 | 10 |
| | | | propionic acid | | | | | | | diisocyanate | | | | | | | | | |
| Polymer32 | 1 | 10⁻⁴ | dimethylol | 0.01 | 30 | 0.1 | 180 | 90 | 5*10⁻⁵ | hexamethylene | 0.01 | 80 | 100 | 215 | 240 | 180 | 50 | 225 | 240 |
| | | | propionic acid | | | | | | | diisocyanate | | | | | | | | | |

TABLE 2
Polymer properties

| | | | | Mean Square | |
|---|---|---|---|---|---|
| | Melt | | Thermal | Radius of | |
| | Strength | Melt Index | Stability | Gyration | Blow |
| | (mN) | (g/10 min) | (° C.) | (nm) | molding |
| Polymer1 | 130 | 14 | 293 | 30 | A |
| Polymer2 | 70 | 28 | 284 | 22 | C |
| Polymer3 | 220 | 8 | 295 | 35 | B |
| Polymer4 | 120 | 15 | 290 | 27 | A |
| Polymer5 | 80 | 27 | 280 | 19 | C |
| Polymer6 | 200 | 9 | 298 | 32 | B |
| Polymer7 | 142 | 13 | 290 | 29 | A |
| Polymer8 | 137 | 17 | 295 | 29 | A |
| Polymer9 | 73 | 28 | 286 | 23 | C |
| Polymer10 | 135 | 15 | 289 | 29 | A |
| Polymer11 | 141 | 16 | 290 | 28 | A |
| Polymer12 | 126 | 17 | 291 | 26 | A |
| Polymer13 | 145 | 13 | 297 | 30 | A |
| Polymer14 | 138 | 14 | 293 | 29 | A |
| Polymer15 | 153 | 12 | 294 | 30 | A |
| Polymer16 | 137 | 14 | 296 | 29 | A |
| Polymer17 | 105 | 19 | 287 | 23 | A |
| Polymer18 | 102 | 20 | 285 | 25 | A |
| Polymer19 | 123 | 16 | 290 | 28 | A |
| Polymer20 | 52 | 30 | 285 | 20 | C |
| Polymer21 | 50 | 31 | 283 | 21 | C |
| Polymer22 | 80 | 27 | 281 | 22 | C |
| Polymer23 | 131 | 15 | 294 | 27 | A |
| Polymer24 | 128 | 16 | 296 | 29 | A |
| Polymer25 | 130 | 15 | 293 | 28 | A |
| Polymer26 | 146 | 14 | 289 | 30 | A |
| Polymer27 | 280 | 7 | 292 | 37 | B |
| Polymer28 | 121 | 16 | 298 | 28 | A |
| Polymer29 | 120 | 18 | 289 | 26 | A |
| Polymer30 | 115 | 18 | 293 | 25 | A |
| Polymer31 | 75 | 27 | 285 | 23 | C |
| Polymer32 | 118 | 18 | 292 | 26 | A |
| Comparative 1 | 50 | 15 | 275 | 20 | C |

As shown in Table 2, the polyglycolic acid (PGA) obtained by using a structure regulator has higher melt strength, better thermal stability and better stability than a comparative linear PGA ring-opening polymerization having a similar melt index and more fit for blow molding.

Although the invention is illustrated and described herein with reference to specific embodiments, the invention is not intended to be limited to the details shown. Rather, various modifications may be made in the details within the scope and range of equivalents of the claims without departing from the invention.

1. A polyglycolic acid comprising first repeating units of formula (I) and second repeating units of E-R₂—F, wherein formula (I) is
wherein: 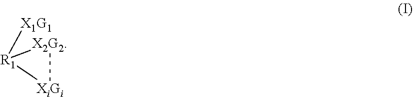
R₁ and R₂ are each an aliphatic or aromatic group;
G₁, G₂ . . . Gᵢ is 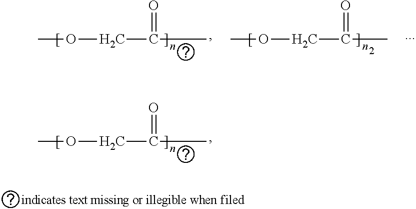
respectively;
i is greater than or equal to 3;
X1, X2 . . . Xi, E and F are each —NH—C(O)—, —O—, —NH— or —C(O)— except:
(a) when each of X1, X2 . . . Xi is —O— or —NH—, E and F are each —NH—C(O)— or —C(O)— and
(b) when each of X1, X2 . . . Xi is —NH—C(O)— or —C(O)—, E and F are each —O— or —NH—.

2. The polyglycolic acid of claim 1, wherein X₁ is —O— or —NH—, X₂ is —C(O)—, and E and F are each —NH—, —NH—C(O)—, —O—, or —C(O)—.

3. The polyglycolic acid of claim 1, wherein each of X₁, X₂ . . . Xᵢ is —O— or —NH—, and E and F are the same and are —NH—C(O)— or —C(O)—.

4. The polyglycolic acid of claim 1, wherein each of X₁, X₂ . . . Xᵢ is —C(O)— or —NH—C(O)—, and E and F are each —O— or —NH—.

5. The polyglycolic acid of claim 1, wherein the polyglycolic acid is prepared from methyl glycolate by polycondensation in the presence of a structure regulator.

6. The polyglycolic acid of claim 1, wherein the polyglycolic acid is prepared according to a three-stage process comprising:
(a) esterifying methyl glycolate in the presence of an esterification catalyst and a structure regulator A in an esterification reactor, whereby a melted pre-esterified polymer is formed;
(b) polycondensing the melted pre-esterified polymer in the presence of a polycondensation catalyst in a polycondensation reactor, whereby a polyglycolic acid based polymer is formed; and
(c) optimizing the polyglycolic acid based polymer in the presence of a structure regulator B in a devolatilization reactor at 200-250° C., under an absolute pressure of not more than 1000 Pa for 10 min to 4 h, whereby the polyglycolic acid is formed.

7. The polyglycolic acid of claim 6, wherein the esterification catalyst comprises a tin salt, a zinc salt, a titanium salt, a sulfonium salt, a tin oxide, a zinc oxide, a titanium oxide, a sulfonium oxide, or a combination thereof.

8. The polyglycolic acid of claim 6, wherein the polycondensation catalyst comprises an oxide, compound or complex of a rare earth element selected from the group consisting of cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y), or a combination thereof

9. The polyglycolic acid of claim 6, wherein the esterification catalyst is tin dichloride dihydrate and the polycondensation catalyst is a rare earth catalyst.

10. The polyglycolic acid of claim 6, wherein the structure regulator A is C1m-R1-D1n (m+n≥3), wherein the structure regulator B is C2-R2-D2, wherein C1, C2, D1 and D2 are each —OH, —COOH, —NH₂, —N═C═O or —COOR5, and wherein R1, R2 and R5 are each an aliphatic or aromatic group.

11. The polyglycolic acid of claim 10, wherein m+n is in the range of 3-8, wherein C1 and D1 are each —OH, —COOH, —NH₂ or —COOR5, wherein R5 is an aliphatic or aromatic group, and wherein C2 and D2 are each —OH, —COOH, —NH₂, —N═C═O.

12. The polyglycolic acid of claim 10, wherein m+n is 3.

13. The polyglycolic acid of claim 6, wherein the structure regulator A is selected from the group consisting of a polyol, a polycarboxylic acid, a polyhydroxypolycarboxyl compound, a polyhydroxypolyester compound, a polyaminopolycarboxyl compound, and a polyaminopolyhydroxy compound.

14. The polyglycolic acid of claim 6, wherein the structure regulator B is a diisocyanate, a dibasic acid, a diamine or a diol.

15. The polyglycolic acid of claim 1, wherein the polyglycolic acid has a property selected from the group consisting of:
(a) a melt index of 5-30 g/10 min at 230° C. and a load of 2.16 g;
(b) a melt strength of 50-300 mN at 230° C. and an acceleration rate at about 1.2 cm/s²;
(c) a temperature of 270° C. or higher when a weight loss rate reaches 3% after being heated starting from room temperature at a heating rate of 2° C./min under a nitrogen atmosphere; and
(d) a combination thereof.

16. The polyglycolic acid of claim 15, wherein the polyglycolic acid is molded by blowing.

17. A process of preparing the polyglycolic acid of claim 1, comprising polycondensing methyl glycolate in the presence of a structure regulator.

18. A process of preparing the polyglycolic acid of claim 1, comprising
(a) esterifying methyl glycolate in the presence of an esterification catalyst and a structure regulator A in an esterification reactor, whereby a melted pre-esterified polymer is formed;
(b) polycondensing the melted pre-esterified polymer in the presence of a polycondensation catalyst in a polycondensation reactor, whereby a polyglycolic acid based polymer is formed; and
(c) optimizing the polyglycolic acid based polymer in the presence of a structure regulator B in a devolatilization reactor at 200-250° C., under an absolute pressure of not more than 1000 Pa for 10 min to 4 h, whereby the polyglycolic acid is formed.

19. The process of claim 18, wherein the esterification catalyst comprises a tin salt, a zinc salt, a titanium salt, a sulfonium salt, a tin oxide, a zinc oxide, a titanium oxide, a sulfonium oxide, or a combination thereof.

20. The process of claim 18, wherein the polycondensation catalyst comprises an oxide, compound or complex of a rare earth element selected from the group consisting of cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y), or a combination thereof.

21. The process of claim 18, wherein the esterification catalyst is tin dichloride dihydrate and the polycondensation catalyst is a rare earth catalyst.

22. The process of claim 18, wherein the structure regulator A is C1m-R1-D1n (m+n≥3), wherein the structure regulator B is C2-R2-D2, wherein C1, C2, D1 and D2 are each —NH₂, —OH, —COOH, —N═C═O or —COOR5, and wherein R1, R2 and R5 are each an aliphatic or aromatic group.

23. The process of claim 18, wherein m+n is in the range of 3-8, wherein C1 and D1 are each —OH, —COOH—, —NH₂, or —COOR5, wherein R5 is an aliphatic or aromatic group, and wherein C2 and D2 are each —OH, —NH₂, —COOH or —N═C═O.

24. The process of claim 22, wherein m+n is 3.

25. The process of claim 18, wherein the structure regulator A is selected from the group consisting of a polyol, a polycarboxylic acid, a polyhydroxypolycarboxyl compound, a polyhydroxypolyester compound, a polyaminopolycarboxyl compound, and a polyaminopolyhydroxy compound.

26. The process of claim 18, wherein the structure regulator B is a diisocyanate, a dibasic acid, diamine or a diol.
